(19) United States
(12) Patent Application Publication
(10) Pub. No.: US 2004/0059504 A1
(43) Pub. Date: Mar. 25, 2004

(54) Method and apparatus to automatically prevent aircraft collisions

(76) Inventor: Christopher R. Gray, Bristol, RI (US)

Correspondence Address: Richard C. Litman, LITMAN LAW OFFICES, LTD., P.O. Box 15035, Arlington, VA, 22215, US

(21) Appl. No.: 10/247,423

(22) Filed: Sep. 20, 2002

(51) Int. Cl. G08G 5/04

(52) U.S. Cl. 701/301; 342/29

(57) ABSTRACT

A method and apparatus to automatically prevent aircraft collisions. An aircraft control system receives internal aircraft data from aircraft sensors and external aircraft data received by radios or transponders. The internal and external aircraft data is provided as input data to at least three microprocessor based central processing units that process the input data and generate recommended control signals. The recommended control signals are received by a control that determines a resultant control signal that is sent to the cockpit and/or a transmitter. If the control is disabled, a backup control determines a resultant control signal that is sent to the cockpit and/or a transmitter. The cockpit outputs the control signal and passes the control signal through a filter. The filter determines if no action is to be taken or if adjustments are to be made to aircraft flight control surfaces and/or the engine.

### BACKGROUND OF THE INVENTION

1. Field of the Invention

The present invention relates generally to aircraft collision avoidance systems and, more particularly, to a method and apparatus to automatically prevent aircraft collisions.

2. Description of the Related Art

Substantial effort has been expended throughout the world to develop flight systems that enhance flight safety. Such systems include, among other things, flight management systems, global navigation satellite systems, differential global positioning systems, air data computers, instrument landing systems, satellite landing systems, traffic alert and collision avoidance systems, weather avoidance systems, thrust management systems, flight control surface systems, flight control computers, etc. These systems rely on traditional error prevention strategies (e.e, error prevention based on structured aircraft design, ergonomics, and training) and are believed to be responsible at reducing the total number of aviation accidents due to human error. Pilot training reinforces the proper way to perform the job. Cockpit and software engineers attempt to make errors very difficult or impossible to commit. In advanced aircraft, automated systems are designed to help pilots control their aircraft more accurately and provide protection from common hazards (e.g., stalls, mid-air collisions, and controlled flight into terrain). These preventative approaches have been practiced for decades and may have reached their limits of effectiveness in further reducing human error rates.

Even with good design and human-factors practices and with initial and recurrent pilot training, not all hazards can be prevented. The complexities of the aviation environment are such that hazards will occur. In dealing with the dynamics of the aviation environment, there is no substitute for human judgment, and that is why human pilots are in command of aircraft. But, being human, pilots may not be able to deal with all hazards before they result in unacceptable consequences. Furthermore, the tragedy of Sep. 11, 2001 clearly demonstrates the hazards associated with a highjacked aircraft. Pilots, therefore, need help in dealing with flight hazards, and the available accident and incident statistics indicate that the current forms of help are insufficient.

The related art is represented by the following references of interest.

U.S. Pat. No. 3,167,772, issued on Jan. 26, 1965 to James J. Bagnall, Jr. et al., describes a collision avoidance system for warning an aircraft in flight of an impending collision with another aircraft. Bagnall, Jr. et al. does not suggest a method and apparatus to automatically prevent aircraft collisions according to the claimed invention.

U.S. Pat. No. 3,550,129, issued on Dec. 22, 1970 to Ernest R. Steele, describes a method and apparatus for warning a pilot of an aircraft of the proximity of another aircraft that utilizes a satellite aided vehicle avoidance system. Steele does not suggest a method and apparatus to automatically prevent aircraft collisions according to the claimed invention.

U.S. Pat. No. 3,566,404, issued on Feb. 23, 1971 to Morris Sorkin, describes a method and apparatus for avoiding collisions between aircraft. Sorkin does not suggest a method and apparatus to automatically prevent aircraft collisions according to the claimed invention.

U.S. Pat. No. 3,757,324, issued on Sep. 4, 1973 to George B. Litchford, describes a method and apparatus for determining the relative bearing from one's own location of a first transponder to the location of another transponder within the service area of a selected secondary surveillance radar that omniazimuthally transmits a reference signal as the main radar beam sweeps through a standardized reference direction. Litchford does not suggest a method and apparatus to automatically prevent aircraft collisions according to the claimed invention.

U.S. Pat. No. 4,153,935, issued on May 8, 1979 to Keith D. Jones et al., describes a navigational aid for calculating the effect of a course and/or speed alteration of one vessel on the nearest approach distance of another vessel, the relative bearing of which is known. Jones et al. does not suggest a method and apparatus to automatically prevent aircraft collisions according to the claimed invention.

U.S. Pat. No. 4,384,293, issued on May 17, 1983 to Paul S. Deem et al., describes a method and apparatus for providing pointing information in accordance with a reference signal produced by at least one global positioning system (GPS) satellite. Deem et al. does not suggest a method and apparatus to automatically prevent aircraft collisions according to the claimed invention.

U.S. Pat. No. 4,418,358, issued on Nov. 29, 1983 to Dieter Poetsch et al., describes a color correction system which is adapted to a film scanner including a digital frame store. Poetsch et al. does not suggest a method and apparatus to automatically prevent aircraft collisions according to the claimed invention.

U.S. Pat. No. 4,623,966, issued on Nov. 18, 1986 to James P. O'Sullivan, describes a method and apparatus for assessing maneuvers of a first vehicle relative to other vehicles. O'Sullivan does not suggest a method and apparatus to automatically prevent aircraft collisions according to the claimed invention.

U.S. Pat. No. 4,644,358, issued on Feb. 17, 1987 to Chogo Sekine, describes an apparatus to confirm an orientation of the stem of a ship by making use of a satellite included in the GPS. Sekine does not suggest a method and apparatus to automatically prevent aircraft collisions according to the claimed invention.

U.S. Pat. No. 4,719,469, issued on Jan. 12, 1988 to Wolfgang Beier et al., describes a direction determining system having a GPS receiver, a linear antenna array, and a fast switching facility. Beier et al. does not suggest a method and apparatus to automatically prevent aircraft collisions according to the claimed invention.

U.S. Pat. No. 4,853,700, issued on Aug. 1, 1989 to Chuhei Funatsu et al., describes a warning airspace indicating system belonging to an aircraft collision avoidance system of a subject aircraft having a function of determining the existence of danger of aircraft collision by receiving response signals from other aircraft in response to interrogation signals delivered from the subject aircraft. Funatsu et al. does not suggest a method and apparatus to automatically prevent aircraft collisions according to the claimed invention.

U.S. Pat. No. 4,963,889, issued on Oct. 16, 1990 to Ronald R. Hatch, describes a method and apparatus for determining the coordinates of a remote receiver antenna relative to a reference receiver antenna. Hatch does not suggest a method and apparatus to automatically prevent aircraft collisions according to the claimed invention.

U.S. Pat. No. 4,994,812, issued on Feb. 19, 1991 to Masahiro Uematsu et al., describes an antenna system which accurately detects a declination of a direction as represented by the directivity of an antenna with respect to a target station or source of a radio wave on a moving body. Uematsu et al. does not suggest a method and apparatus to automatically prevent aircraft collisions according to the claimed invention.

U.S. Pat. No. 5,029,092, issued on Jul. 2, 1991 to Chuhei Funatsu, describes a device of suppressing incorrect alarms to be issued from an aircraft collision avoidance system installed in a first aircraft. Funatsu does not suggest a method and apparatus to automatically prevent aircraft collisions according to the claimed invention.

U.S. Pat. Nos. 5,077,673 and 5,157,615, issued on Dec. 31, 1991 to William C. Brodegard et al., describe a proximity warning system and method, respectively, for an aircraft that is based on evaluation of replies from transponders of other aircraft to interrogations from a secondary surveillance radar. Brodegard et al. '673 and '615 do not suggest a method and apparatus to automatically prevent aircraft collisions according to the claimed invention.

U.S. Pat. No. 5,128,700, issued on Jul. 7, 1992 to Manabu Inoue et al., describes a data recording camera capable of photographing an object image frame by frame of film and capable of recording sound data corresponding to the photography. Inoue et al. does not suggest a method and apparatus to automatically prevent aircraft collisions according to the claimed invention.

U.S. Pat. No. 5,177,489, issued on Jan. 5, 1993 to Ronald R. Hatch, describes a method for determining the coordinates of a remote receiver antenna relative to a reference receiver antenna, using a signal received from one or more psuedo satellites, or pseudolites. Hatch does not suggest a method and apparatus to automatically prevent aircraft collisions according to the claimed invention.

U.S. Pat. No. 5,276,472, issued on Jan. 4, 1994 to Cynthia S. Bell et al., describes a photographic still picture audio recording system adapted to provide audio recording in association with still photographic pictures. Bell et al. does not suggest a method and apparatus to automatically prevent aircraft collisions according to the claimed invention.

U.S. Pat. No. 5,128,700, issued on Jul. 7, 1992 to Aviv Izidon et al., describes a warning system for predicting collision between two or more relatively moving objects. Izidon et al. does not suggest a method and apparatus to automatically prevent aircraft collisions according to the claimed invention.

U.S. Pat. No. 5,388,047, issued on Feb. 7, 1995 to Dean E. Ryan et al., describes a proximity warning device for aircraft that responds solely to transmissions from transponders. Ryan et al. does not suggest a method and apparatus to automatically prevent aircraft collisions according to the claimed invention.

U.S. Pat. No. 5,422,816, issued on Jun. 6, 1995 to David S. Sprague et al., describes a portable personal navigation tracking system. Sprague et al. does not suggest a method and apparatus to automatically prevent aircraft collisions according to the claimed invention.

U.S. Pat. No. 5,430,656, issued on Jul. 4, 1995 to Itzhak Dekel et al., describes a vehicle locator and communication system. Dekel et al. does not suggest a method and apparatus to automatically prevent aircraft collisions according to the claimed invention.

U.S. Pat. No. 5,434,787, issued on Jul. 18, 1995 to Naoki Okamoto et al., describes a GPS position measuring system. Okamoto et al. does not suggest a method and apparatus to automatically prevent aircraft collisions according to the claimed invention.

U.S. Pat. No. 5,442,363, issued on Aug. 15, 1995 to Benjamin W. Remondi, describes a method and apparatus for determining the precise coordinate of a remote roving on-the-fly signal receiver with respect to a reference signal receiver. Remondi does not suggest a method and apparatus to automatically prevent aircraft collisions according to the claimed invention.

U.S. Pat. No. 5,757,468, issued on May 26, 1998 to David L. Patton et al., describes a method and apparatus for printing sound code icons on photographic prints produced from filmstrips having images with varying orientation, size, and/or format. Patton et al. '468 does not suggest a method and apparatus to automatically prevent aircraft collisions according to the claimed invention.

U.S. Pat. No. 5,774,752, issued on Jun. 30, 1998 to David L. Patton et al., describes a method of processing photographic still image film orders having sound information recorded at the camera in association with one or more images captured on the film in which sound information is downloaded at an order entry station to create a sound file for transfer to the photofinising laboratory. Patton et al. '752 does not suggest a method and apparatus to automatically prevent aircraft collisions according to the claimed invention.

U.S. Pat. No. 5,897,639, issued on Apr. 27, 1999 to Arthur R. Greef et al., describes a catalog database system and method in which there are a plurality of catalog objects. Greef et al. does not suggest a method and apparatus to automatically prevent aircraft collisions according to the claimed invention.

U.S. Pat. Nos. 5,983,161 and 6,275,773 B1, issued on Nov. 9, 1999 and Aug. 14, 2001, respectively, to Jerome H. Lemelson et al., describe a computer controlled collision avoidance and warning method and system. Lemelson et al. '161 and '773 do not suggest a method and apparatus to automatically prevent aircraft collisions according to the claimed invention.

U.S. Pat. No. 6,015,540, issued on Jan. 18, 2000 to Nazar Zaidi et al., describes a method and apparatus for scheduling instructions in waves. Zaidi et al. does not suggest a method and apparatus to automatically prevent aircraft collisions according to the claimed invention.

U.S. Pat. No. 6,064,987, issued on May 16, 2000 to Jay S. Walker et al., describes a method and apparatus for providing and processing installment plans at a terminal. Walker et al. does not suggest a method and apparatus to automatically prevent aircraft collisions according to the claimed invention.

U.S. Pat. No. 6,070,157, issued on May 30, 2000 to Guy Jacobson et al., describes a method for providing more informative results in response to a search of electronic documents. Jacobson et al. does not suggest a method and apparatus to automatically prevent aircraft collisions according to the claimed invention.

Japan Patent document 4-15799, published on Jan. 21, 1992, describes a vehicle controller that performs correction of the vehicle in accordance with road information generated by a navigation system in the vehicle. Japan '799 does not suggest a method and apparatus to automatically prevent aircraft collisions according to the claimed invention.

Japan Patent document 4-219900, published on Aug. 10, 1992, describes a vehicle distance confirmation device. Japan '900 does not suggest a method and apparatus to automatically prevent aircraft collisions according to the claimed invention.

Japan Patent document 5-143897, published on Jun. 11, 1993, describes a moving body recognition device for a vehicle. Japan '897 does not suggest a method and apparatus to automatically prevent aircraft collisions according to the claimed invention.

None of the above inventions and patents, taken either singularly or in combination, is seen to describe the instant invention as claimed. Thus a method and apparatus to automatically prevent aircraft collisions solving the aforementioned problems is desired.

### SUMMARY OF THE INVENTION

The present invention is a method and apparatus to automatically prevent aircraft collisions. An apparatus to automatically prevent aircraft collisions according to the invention receives internal aircraft data from aircraft sensors and external aircraft data received by radios or transponders. The internal and external aircraft data is provided as input data to at least three microprocessor based central processing units (CPUs). The CPUs process the input data and generate recommended control signals. The recommended control signals are received by a control that is backed up by a backup control. The control determines a resultant control signal that is sent to the cockpit and/or a transmitter. If the control is disabled, the backup control determines a resultant control signal that is sent to the cockpit and/or a transmitter. The cockpit outputs the control signal and passes the control signal through a filter. The filter determines if no action is to be taken or if adjustments are to be made to aircraft flight control surfaces and/or the engine.

Each CPU includes an arithmetic/logic unit that is interconnected with a read only memory (ROM) and a random access memory (RAM). The ROM stores first computer readable program code means that is read and processed by the CPU, and that causes the CPU to perform programmed functions. The ROM may be electronically alterable (e.g., EPROM, EEPROM, or the like) so that the processing circuitry can be readily adapted to a particular aircraft configuration.

The first computer readable program code means may include first computer instruction means that processes the input data and predicts whether the aircraft will have a collision within a predetermined amount of time. The first computer readable program code means may include second computer instruction means that generates a recommended command signal based on the processed input data. The first computer readable program code means may include third computer instruction means that processes either pilot or aircraft control system input, converts these inputs into control variables for actuator feedback systems, and generates an associated recommended command signal (e.g., the flight control surfaces, the engine, etc.).

The first computer readable program code means may include fourth computer instruction means that processes input data and overrides the pilot and/or autopilot if the input data includes override instructions transmitted from ground control. The first computer readable program code means may include fifth computer instruction means that processes input data and overrides the pilot and/or autopilot if adjustment of flight control surfaces and/or the engine requires immediate action or action within a predetermined minimum amount of time to steer the aircraft out of harms way. The first computer readable program code means may include sixth computer instruction means that processes input data and causes the transmitter to automatically send a reporting signal, distress signal, or the like, to the ground, to alert ground personnel to contact the pilot and/or take control of the aircraft in the event that the pilot has become disabled or is improperly operating the aircraft.

The control and backup control each include second computer readable program means. The second computer readable program means may include first computer instruction means that processes the recommended command signals generated by the CPUs by evaluating the recommended command signals and determining a recommended command signal that received a majority vote of the CPUs. The second computer readable program means may include second computer instruction means that instructs the CPUs to sequentially process the input data for a predetermined number of times if no majority vote is determined until a majority vote is determined. The second computer readable program means may include third computer instruction means that provides a command signal based on the recommended command signals that have been generated to that point for the same input data if no majority vote is determined after the predetermined number of times is reached.

Command signals generated by the control may cause no warning or advisory to the cockpit if a collision of the aircraft is not imminent. Command signals generated by the control may include aural or visual resolution advisories and/or traffic advisories if a collision of the aircraft is imminent. Command signals generated by the control may also include command signals to adjust the flight control surfaces and/or the engines of the aircraft to avoid a collision.

The orientation of an aircraft may be controlled in three axes, namely, yaw, pitch, and roll. The pitch axis extends along the wingspan of the aircraft, the roll axis extends along the length of the aircraft, and the yaw axis is perpendicular to both the pitch axis and the roll axis. Command signals that cause adjustment of the aircraft flight control surfaces include effecting pitch control of elevators, one on each horizontal stabilizer, and pitch trim by a movable horizontal stabilizer. Command signals that cause adjustment of aircraft flight control surfaces also includes effecting roll control with inboard and outboard ailerons supplemented by wing spoilers. Command signals that cause adjustment of aircraft flight control surfaces also include effecting yaw control by effecting rudder movement on a vertical stabilizer. Flaps may be extended rearwardly and downwardly to increase wing resistance when desired. Lateral dynamics of the aircraft may be controlled by a yaw damper integrated as part of the aircraft control system, and longitudinal stability augmentation may be provided by the aircraft control system through pitch dynamics. All of the lateral and pitch dynamic surfaces may be controlled by hydraulic actuators.

The CPUs are configured in parallel and, simultaneously, each processes the input data and generates a recommended command signal based on the processed input data. Each recommended command signal is then combined and processed by a control which evaluates the recommended command signals from the CPUs and determines the majority vote of the CPUs. If a majority vote is not determined, the control instructs the CPUs to sequentially process the input data for a predetermined number of times until a majority vote is determined. If no majority vote is determined after the predetermined number of times is reached, the control will provide a command signal based on the recommended command signals that have been generated to that point. A backup control is also provided to protect against failure of the control.

A method to automatically prevent aircraft collisions includes inputting internal and external aircraft into a plurality of processing units; processing the input data in each processing unit and determining a recommended control signal; evaluating the recommended command signals from each processing unit and determining a recommended command signal that received a majority vote of the processing units; instructing the processing units to sequentially process the same input data for a predetermined number of times if no majority vote is determined until a majority vote is determined; and providing a command signal based on the recommended command signals that have been generated to that point for the same input data if no majority vote is determined after the predetermined number of times is reached.

The method to automatically prevent aircraft collisions may also include providing a command signal that causes no warning or advisory to the cockpit if a collision of the aircraft is not imminent; providing a command signal that causes an aural or visual resolution advisory and/or traffic advisory in the cockpit of the aircraft if a collision of the aircraft is imminent; and providing a command signal that adjusts the flight control surfaces and/or the engines of the aircraft to avoid a collision.

Accordingly, it is a principal aspect of the invention to provide an apparatus to automatically prevent aircraft collisions that includes input means for inputting data to a plurality of processing units, at least three processing units communicatively connected to the input means for inputting data, a control communicatively connected to the at least three processing units, a backup control communicatively connected to the control, a transmitter communicatively connected to the control, and a filter communicatively connected to control.

It is another aspect of the invention to provide an apparatus to automatically prevent aircraft collisions that includes at least three processing units that each have first computer readable program code means including first computer instruction means for processing input data and predicting whether an aircraft will have a collision within a predetermined amount of time, second computer instruction means for generating a recommended command signal based on the processed input data, third computer instruction means for processing either pilot or aircraft control system input, converting these inputs into control variables for actuator feedback systems, and generating an associated recommended command signal; and fourth computer instruction means for processing the input data and overriding aircraft controls by the pilot or autopilot if the input data includes override instructions transmitted from a position remote to the aircraft.

It is a further aspect of the invention to provide an apparatus to automatically prevent aircraft collisions that includes at least three processing units that each have first computer readable program code means including first computer instruction means for processing input data and predicting whether an aircraft will have a collision within a predetermined amount of time, second computer instruction means for generating a recommended command signal based on the processed input data, third computer instruction means for processing either pilot or aircraft control system input, converting these inputs into control variables for actuator feedback systems, and generating an associated recommended command signal; fourth computer instruction means for processing the input data and overriding aircraft controls by the pilot or autopilot if the input data includes override instructions transmitted from a position remote to the aircraft; fifth computer instruction means for processing input data and overriding the pilot and/or autopilot if adjustment of flight control surfaces and/or the engine requires immediate action or action within a predetermined minimum amount of time to steer the aircraft out of harms way; and sixth computer instruction means for processing input data and causing a transmitter to automatically send a signal to ground personnel to alert ground personnel to contact the pilot and/or take control of the aircraft in the event that the pilot has become disabled.

Still another aspect of the invention is to provide a method to automatically prevent aircraft collisions including inputting internal and external aircraft into a plurality of processing units; processing the input data in each processing unit and determining a recommended control signal; evaluating the recommended command signals from each processing unit and determining a recommended command signal that received a majority vote of the processing units; instructing the processing units to sequentially process the same input data for a predetermined number of times if no majority vote is determined until a majority vote is determined; and providing a command signal based on the recommended command signals that have been generated to that point for the same input data if no majority vote is determined after the predetermined number of times is reached, wherein the command signal may cause no warning or advisory to a cockpit of an aircraft if a collision of the aircraft is not imminent, may cause an aural or visual resolution advisory if a collision of the aircraft is imminent, or may cause an aural or visual traffic advisory in a cockpit of an aircraft if a collision of the aircraft is imminent.

It is an aspect of the invention to provide improved elements and arrangements thereof for a method and apparatus to automatically prevent aircraft collisions for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is side perspective view of two aircraft in flight, each aircraft being equipped with an apparatus to automatically prevent aircraft collisions according to the invention.

FIG. 2 is a side perspective view of an aircraft equipped with an apparatus to automatically prevent aircraft collisions according to the invention.

FIG. 3 is a block diagram of an apparatus to automatically prevent aircraft collisions according to the invention.

Similar reference characters denote corresponding features consistently throughout the attached drawings.

### DETAILED DESCRIPTION OF THE PREFERRED EMBODIMENTS

The present invention is a method and apparatus to automatically prevent aircraft collisions. The invention disclosed herein is, of course, susceptible of embodiment in many different forms. Shown in the drawings and described hereinbelow in detail is are preferred embodiments of the invention. It is to be understood, however, that the present disclosure is an exemplification of the principles of the invention and does not limit the invention to the illustrated embodiments.

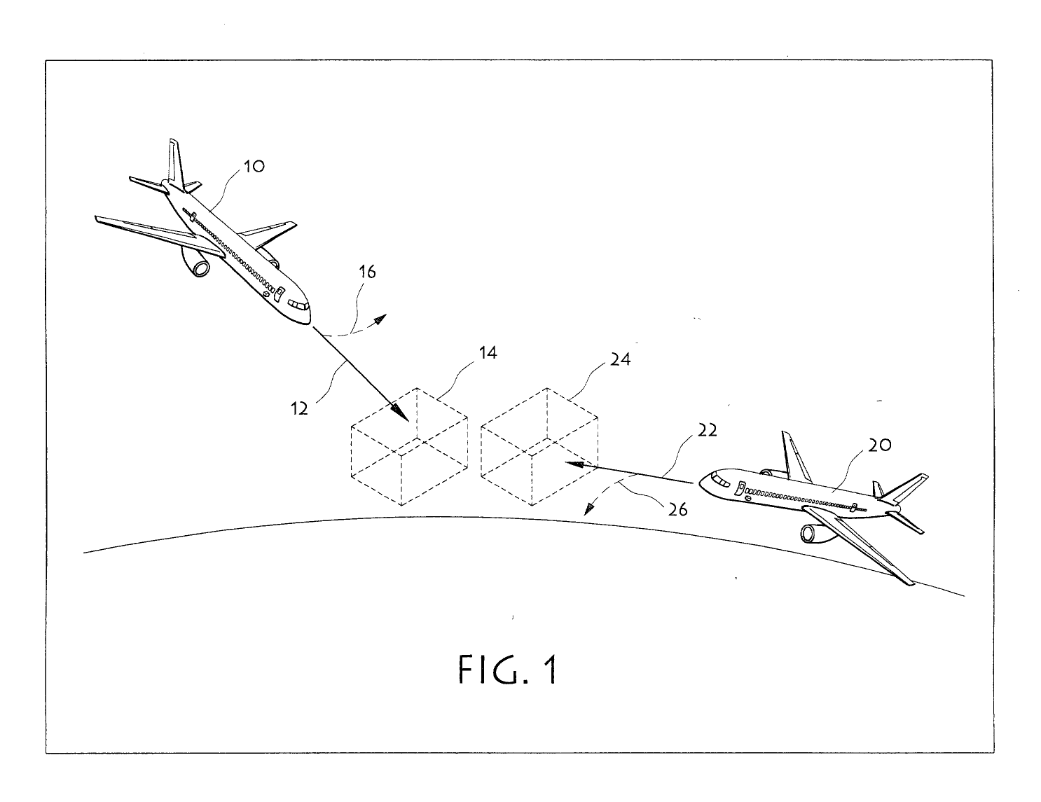

Referring now to the drawings, FIG. 1 illustrates two aircraft 10 and 20 in flight. Aircraft 10 and 20 are each equipped with an aircraft control system according to the invention. Each aircraft 10 and 20 are flying along respective flight paths 12 and 22 and their control systems are operating to maintain their respective “safety bubbles” 14 and 24 from impacting a hazardous condition, such as impact with another “safety bubble” of another aircraft, a ground object, or the like.

Safety bubbles 14 and 24 represent air pocket locations where the aircraft are predicted to be a predetermined amount of time in the future. These air pocket locations are determined based on computations of aircraft parametric data (e.g., using algorithmic models or the like). The aircraft control system of each aircraft estimates whether their particular predicted air pocket locations are at risk of intrusion by an object (e.g., the ground, another aircraft, a building, etc.). Typical air traffic control separation standards require a five nautical mile radius and height of 2000 feet (altitude−1000 feet to altitude+1000 feet). An intrusion or conflict occurs when a minimum distance in time-space between an aircraft safety bubble is less than a required minimum separation distance. When the aircraft control system predicts an intrusion or conflict, the aircraft control system will generate a command signal.

The command signal may cause an aural or visual flight advisory to be presented in the flight cockpit (e.g., “PULL UP”, “BANK RIGHT”, “BANK LEFT”, etc.). Such a flight advisory may include a resolution advisory or a traffic advisory. Resolution advisories may include a preventive resolution advisory or a corrective resolution advisory. A preventive resolution advisory may require no immediate action but may warn the pilot not to climb, descend, or adjust vertical speed due to nearby traffic. A corrective resolution advisory may direct the pilot to alter the vertical speed of the aircraft to ensure safe separation from nearby traffic in the vertical plane. Traffic advisories may indicate the positions of intruding aircraft that may later cause resolution advisories to be displayed. In potential collision encounters, a command signal may be generated that causes a traffic advisory to occur a predetermined amount of time before a resolution advisory.

The command signal may also cause the pilot's controls to be overridden and to positively control the flight control surfaces and/or the engine of the aircraft. Such a command signal would result from ground transmissions by flight qualified individuals would could then proactively control the aircraft in the event of a highjacking, flight crew injury, etc., to safely bring the aircraft to the ground and to avoid other aircraft, terrain, buildings, etc. In addition, such an override command signal could be automatically generated by the aircraft control system if the aircraft control system determines that adjustment of flight control surfaces and/or the engine required immediate action or action within a predetermined minimum amount to steer the aircraft out of harms way. For example, if the aircraft control system determined that the aircraft was about to collide with a mountain or a building, the aircraft control system could generate an override control signal to automatically adjust the flight control surfaces and/or the engine to bring the aircraft to a different altitude. At the same time, the aircraft control system could automatically send a reporting signal, distress signal, or the like, to the ground, to alert ground personnel to contact the pilot and/or take control of the aircraft in the event that the pilot has become disabled.

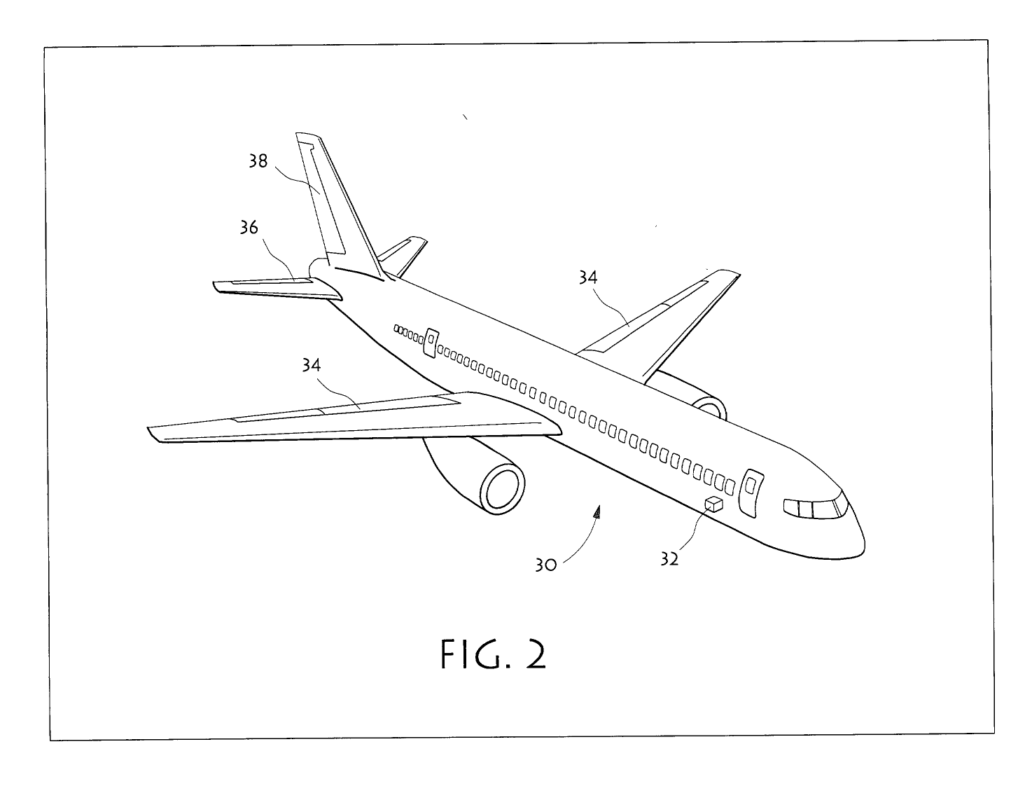

As shown in FIG. 2, an aircraft 30 is equipped with aircraft control system 32. Aside from aircraft control system 32, aircraft 30 represents a conventional aircraft and includes flight surfaces 34, 36, and 38. Aircraft 30 also includes a plurality of conventional sensors for detecting aircraft parametric conditions, such as pressure, temperature, airspeed, wind speed, altitude, heading, fuel level, flap position, rudder position, etc. Aircraft 30 also includes one or more transponders for transmitting data regarding the internal aircraft parameters and/or receiving data regarding external aircraft parameters (e.g., air traffic control instructions, data from other aircraft or objects, terrain, data from GPS satellites, etc.), and conventional aircraft controls for controlling flight control surfaces 34, 36, and 38. Aircraft 10 also includes a display for displaying navigation information, displaying traffic advisories, maps, flight plans, etc.

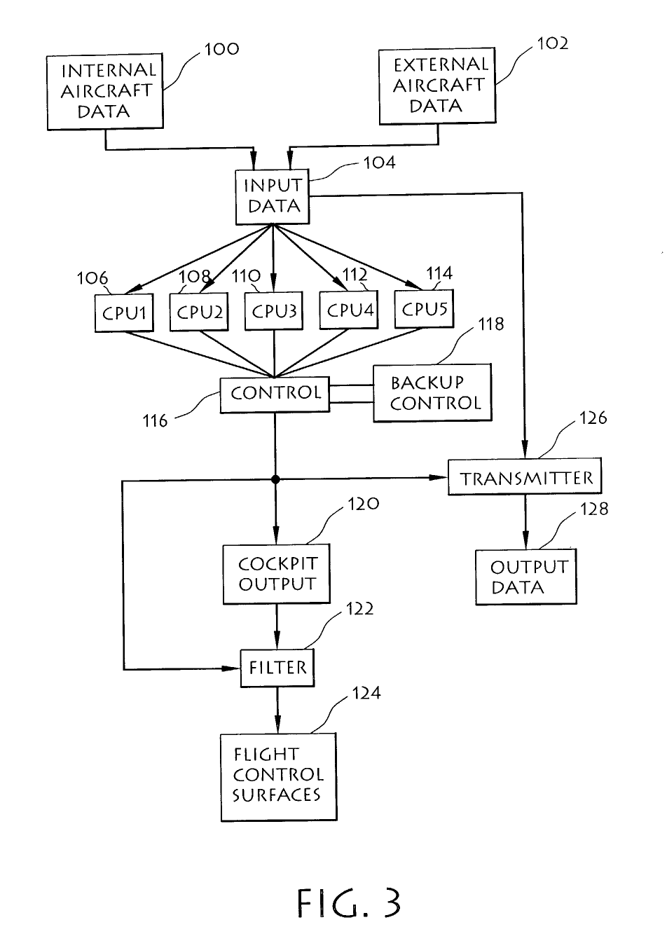

As shown in FIG. 3, an aircraft control system according to the invention receives internal aircraft data 100 from aircraft sensors and external aircraft data 102 received by radios or transponders. Aircraft data may also be provided by the pilot or by data retrieved from stored databases. For example, the aircraft control system may store geographical data of ground terrain altitudes and ground terrain man-made structures (e.g., buildings, statues, or the like). Such data may be uploaded to the aircraft control system at airports and/or may be wirelessly uploaded during flight while the aircraft is in the air. The internal and external aircraft data is electronically or wirelessly provided as input data 104 to at least three microprocessor based CPUs 106, 108, 110, 112, and 114. The use of at least three CPUs provides enhanced aircraft safety due to redundancy. For example, if each CPU 106, 108, 110, 112, and 114 processes the same input data and one CPU becomes inoperative or disabled, the other operational CPUs will be able to provide aircraft control. Alternatively, each CPU 106, 108, 110, 112, and 114 may receive different sets of input data to protect against sensors that become inoperative, inaccurate, or disabled. For example, plural sensors may be utilized to measure temperature, and each CPU 106, 108, 110, 112, and 114 may receive temperature input data from a predetermined temperature sensor that differs from the other CPUs.

Each CPU includes an arithmetic/logic unit that is interconnected with a ROM and a RAM. The ROM stores first computer readable program code means that is read and processed by the CPU, and that causes the CPU to perform programmed functions. The ROM may be electronically alterable (e.g., EPROM, EEPROM, or the like) so that the processing circuitry can be readily adapted to a particular aircraft configuration.

The first computer readable program code means may include first computer instruction means that processes input data 104 and predicts whether the aircraft will have a collision within a predetermined amount of time. The first computer readable program code means may include second computer instruction means that generates a recommended command signal based on the processed input data. The first computer readable program code means may include third computer instruction means that processes either pilot or aircraft control system input, converts these inputs into control variables for actuator feedback systems, and generates an associated recommended command signal (e.g., the flight control surfaces, the engine, etc.). The first computer readable program code means may include fourth computer instruction means that processes input data 104 and overrides the pilot and/or autopilot if the input data includes override instructions transmitted from ground control. The first computer readable program code means may include fifth computer instruction means that processes input data 104 and overrides the pilot and/or autopilot if adjustment of flight control surfaces and/or the engine requires immediate action or action within a predetermined minimum amount of time to steer the aircraft out of harms way. The first computer readable program ode means may include sixth computer instruction means that processes input data 104 and causes the transmitter to data 104 and causes the transmitter to automatically send a reporting signal, distress signal, or the like, to the ground, to alert ground personnel to contact the pilot and/or take control of the aircraft in the event that the pilot has become disabled or is improperly operating the aircraft.

Control 116 and backup control 118 each include second computer readable program means. The second computer readable program means may include first computer instruction means that processes the recommended command signals generated by CPUs 106, 108, 110, 112, and 114 by evaluating the recommended command signals and determining a recommended command signal that received a majority vote of CPUs 106, 108, 110, 112, and 114. The second computer readable program means may include second computer instruction means that instructs CPUs 106, 108, 110, 112, and 114 to sequentially process the same input data 104 for a predetermined number of times if no majority vote is determined until a majority vote is determined. The second computer readable program means may include third computer instruction means that provides a command signal based on the recommended command signals that have been generated to that point for the same input data if no majority vote is determined after the predetermined number of times is reached.

Command signals generated by control 116 may cause no warning or advisory to the cockpit if a collision of the aircraft is not imminent. Command signals generated by control 116 may include aural or visual resolution advisories and/or traffic advisories if a collision of the aircraft is imminent. Command signals generated by control 116 may also include command signals to adjust the flight control surfaces and/or the engines of the aircraft to avoid a collision.

The orientation of an aircraft may be controlled in three axes, namely, yaw, pitch, and roll. The pitch axis extends along the wingspan of the aircraft, the roll axis extends along the length of the aircraft, and the yaw axis is perpendicular to both the pitch axis and the roll axis. Command signals that cause adjustment of aircraft flight control surfaces 124 include effecting pitch control of elevators, one on each horizontal stabilizer, and pitch trim by a movable horizontal stabilizer. Command signals that cause adjustment of aircraft flight control surfaces 124 also include effecting roll control with inboard and outboard ailerons supplemented by wing spoilers. Command signals that cause adjustment of aircraft flight control surfaces 124 also include effecting yaw control by effecting rudder movement on a vertical stabilizer. Flaps may be extended rearwardly and downwardly to increase wing resistance when desired. Lateral dynamics of the aircraft may be controlled by a yaw damper integrated as part of the aircraft control system, and longitudinal stability augmentation may be provided by the aircraft control system through pitch dynamics. All of the lateral and pitch dynamic surfaces may be controlled by hydraulic actuators.

The CPUs 106, 108, 110, 112, and 114 are configured in parallel and, simultaneously, each processes the input data 104 and generates a recommended command signal based on the processed input data. Each recommended command signal is then combined and processed by a control which evaluates the recommended command signals from the CPUs and determines the majority vote of CPUs 106, 108, 110, 112, and 114. If a majority vote is not determined, the control instructs CPUs 106, 108, 110, 112, and 114 to sequentially process the same input data 104 for a predetermined number of times until a majority vote is determined. If no majority vote is determined after the predetermined number of times is reached, the control 116 will provide a command signal based on the recommended command signals that have been generated to that point. A backup control 118 is also provided to protect against failure of the control 116.

A method to automatically prevent aircraft collisions includes inputting internal and external aircraft into a plurality of processing units; processing the input data in each processing unit and determining a recommended control signal; evaluating the recommended command signals from each processing unit and determining a recommended command signal that received a majority vote of the processing units; instructing the processing units to sequentially process the same input data for a predetermined number of times if no majority vote is determined until a majority vote is determined; and providing a command signal based on the recommended command signals that have been generated to that point for the same input data if no majority vote is determined after the predetermined number of times is reached.

The method to automatically prevent aircraft collisions may also include providing a command signal that causes no warning or advisory to the cockpit if a collision of the aircraft is not imminent; providing a command signal that causes an aural or visual resolution advisory and/or traffic advisory in the cockpit of the aircraft if a collision of the aircraft is imminent; and providing a command signal that adjusts the flight control surfaces and/or the engines of the aircraft to avoid a collision.

Never again could an aircraft be used as a missile to cause death and destruction. It will no longer be necessary to even think about shooting down commercial jetliners in the event of a terrorist takeover because the aircraft will not allow itself to be crashed. Some research indicates that the leading cause of aircraft accidents in the future will be midair collisions. If we could eliminate that as a potential threat, how much safer would air travel be? Pilots have limited visibility out of the cockpit. An aircraft control system according to the present invention will prevent collisions with aircraft and objects the pilot can't even see. An example of this is a radio tower on a foggy night and the aircraft on low approach. The aircraft control system would compare the aircraft's position with that of the tower. The aircraft control system may determine that the aircraft “safety bubble” would collide with the tower within a predetermined amount of time, such as fifteen seconds, if no action is taken, and would automatically notify the cockpit and pull the aircraft up to an acceptable altitude, potentially averting disaster. In the event of a terrorist take over, land-based personnel may seize control of the aircraft, so the plane can be safely landed, thereby ending the situation without any significant damage to the aircraft or people on the ground.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. An apparatus to automatically prevent aircraft collisions comprising:
input means for inputting data to a plurality of processing units;
at least three processing units communicatively connected to the input means for inputting data;
a control communicatively connected to the at least three processing units;
a backup control communicatively connected to the control;
a transmitter communicatively connected to the control; and
a filter communicatively connected to the control.

2. An apparatus according to claim 1, wherein said input means receives internal aircraft data from aircraft sensors.

3. An apparatus according to claim 1, wherein said input means receives external aircraft data from radios or transponders.

4. An apparatus according to claim 1, wherein said at least three processing units includes an arithmetic/logic unit that is interconnected with a read only memory (ROM) and a random access memory (RAM).

5. An apparatus according to claim 4, wherein said ROM stores first computer readable program code means that includes first computer instruction means for processing input data and predicting whether an aircraft will have a collision within a predetermined amount of time.

6. An apparatus according to claim 5, wherein said first computer readable program code means that includes second computer instruction means for generating a recommended command signal based on the processed input data.

7. An apparatus according to claim 5, wherein said first computer readable program code means that includes third computer computer instruction means for processing either pilot or aircraft control system input, converting these inputs into control variables for actuator feedback systems, and generating an associated recommended command signal.

8. An apparatus according to claim 5, wherein said first computer readable program code means that includes fourth computer instruction means for processing the input data and overriding aircraft controls by the pilot or autopilot if the input data includes override instructions transmitted from a position remote to the aircraft.

9. An apparatus according to claim 5, wherein said first computer readable program code means that includes fifth computer instruction means that processes input data and overrides the pilot and/or autopilot if adjustment of flight control surfaces and/or an engine requires immediate action or action within a predetermined minimum amount of time to steer an aircraft out of harms way.

10. An apparatus according to claim 5, wherein said first computer readable program code means that includes sixth computer instruction means for processing input data and causing the transmitter to automatically send a signal to ground personnel to alert ground personnel that an aircraft operator is disabled.

11. An apparatus according to claim 1, wherein said control and said backup control each store second computer readable program means that includes first computer instruction means for processing recommended command signals generated by said at least three processing units by evaluating the recommended command signals and determining a recommended command signal that received a majority vote of the processing units.

12. An apparatus according to claim 11, wherein said second computer readable program means includes second computer instruction means for instructing said at least three processing units to sequentially process input data for a predetermined number of times if no majority vote is determined until a majority vote is determined.

13. An apparatus according to claim 12, wherein said second computer readable program means includes third computer instruction means for providing a determined command signal based on the recommended command signals that have been generated to that point for the same input data if no majority vote is determined after said predetermined number of times is reached.

14. An apparatus according to claim 13, wherein said determined command signal causes no warning or advisory to the cockpit if a collision of the aircraft is not imminent.

15. An apparatus according to claim 13, wherein said determined command signal causes an aural or visual advisory if a collision of the aircraft is imminent.

16. An apparatus according to claim 13, wherein said determined command signal adjusts flight control surfaces or engines of the aircraft to avoid a collision.

17. A computer readable medium for an aircraft, said computer readable medium comprising:
first computer readable program code means that includes first computer instruction means for processing input data and predicting whether an aircraft will have a collision within a predetermined amount of time.

18. The computer readable medium according to claim 17, wherein said first computer readable program code means includes second computer instruction means for generating a recommended command signal based on the processed input data.

19. The computer readable medium according to claim 17, wherein said first computer readable program code means includes third computer instruction means for processing either pilot or aircraft control system input, converting these inputs into control variables for actuator feedback systems, and generating an associated recommended command signal.

20. The computer readable medium according to claim 17, wherein said first computer readable program code means includes fourth computer instruction means for processing the input data and overriding aircraft controls by the pilot or autopilot if the input data includes override instructions transmitted from a position remote to the aircraft.

21. The computer readable medium according to claim 17, wherein said first computer readable program code means includes fifth computer instruction means for processing input data and overriding the pilot and/or autopilot if adjustment of flight control surfaces and/or the engine requires immediate action or action within a predetermined minimum amount of time to steer an aircraft out of harms way.

22. The computer readable medium according to claim 17, wherein said first computer readable program code means includes sixth computer instruction means for processing input data and causing a transmitter to automatically send a signal to ground personnel to alert ground personnel that an aircraft operator is disabled.

23. The computer readable medium according to claim 17, further comprising second computer readable program means that includes first computer instruction means for processing recommended command signals generated by at least three processing units by evaluating the recommended command signals and determining a recommended command signal that received a majority vote of the processing units.

24. An apparatus according to claim 23, wherein said second computer readable program means includes second computer instruction means for instructing the at least three processing units to sequentially process input data for a predetermined number of times if no majority vote is determined until a majority vote is determined.

25. An apparatus according to claim 23, wherein said second computer readable program means includes third computer instruction means for providing a determined command signal based on the recommended command signals that have been generated to that point for the same input data if no majority vote is determined after said predetermined number of times is reached.

26. A method to automatically prevent aircraft collisions comprising:
inputting internal and external aircraft into a plurality of processing units;
processing the input data in each processing unit and determining a recommended control signal;
evaluating the recommended command signals from each processing unit and determining a recommended command signal that received a majority vote of the processing units;
instructing the processing units to sequentially process the same input data for a predetermined number of times if no majority vote is determined until a majority vote is determined; and
providing a command signal based on the recommended command signals that have been generated to that point for the same input data if no majority vote is determined after the predetermined number of times is reached.

27. A method according to claim 26, wherein said step of providing a command signal further comprises providing a command signal that causes no warning or advisory to a cockpit of an aircraft if a collision of the aircraft is not imminent

28. A method according to claim 26, wherein said step of providing a command signal further comprises providing a command that causes an aural or visual resolution advisory if a collision of the aircraft is imminent.

29. A method according to claim 26, wherein said step of providing a command signal further comprises providing a command signal that causes an aural or visual traffic advisory in a cockpit of an aircraft if a collision of the aircraft is imminent.

30. A method according to claim 26, wherein said step of providing a command signal further comprises providing a command signal that adjusts flight control surfaces.

31. A method according to claim 26, wherein said step of providing a command signal further comprises providing a command signal that adjusts engines of an aircraft to avoid a collision.
